(19) United States
(12) Patent Application Publication
(10) Pub. No.: US 2025/0140883 A1
(43) Pub. Date: May 1, 2025

(54) SYSTEMS AND METHODS FOR MANAGING FUEL CELL EXHAUST WATER

(71) Applicant: GM GLOBAL TECHNOLOGY OPERATIONS LLC, Detroit, MI (US)

(72) Inventors: Daryl J. D'Andrea, Holly, MI (US); Dawid Siekierka, Livonia, MI (US); Patrick M. Hoover, Keego Harbor, MI (US); Andrei Balaceanu, Whitby (CA); Lei Li, Whitby (CA)

(73) Assignee: GM GLOBAL TECHNOLOGY OPERATIONS LLC, Detroit, MI (US)

(21) Appl. No.: 18/494,349

(22) Filed: Oct. 25, 2023

(51) Int. Cl. H01M 8/04746; H01M 8/04082; H01M 8/0432

(52) U.S. Cl. CPC H01M 8/04761; H01M 8/04201; H01M 8/04343; H01M 8/0435; H01M 2250/20

(57) ABSTRACT

An exhaust liquid treatment assembly for a fuel cell system (FCS). The FCS includes a fuel cell stack and an FCS exhaust pipe fluidly connected to the fuel cell stack and configured to expel an exhaust stream from the FCS. The exhaust liquid treatment assembly includes a liquid tank having a liquid inlet in fluid communication with the FCS exhaust pipe and a liquid outlet. A liquid treatment filter separates the liquid inlet from the liquid outlet and includes a pH controlling material configured to mix with a liquid passing through the liquid treatment filter. A liquid level sensor configured to determine a level of liquid in the liquid tank. A controller is in communication with the liquid level sensor and configured to regulate a level of the liquid within the liquid tank by selectively opening and closing an outlet valve in fluid communication with the liquid outlet.

### INTRODUCTION

The present disclosure relates generally to electrochemical fuel cell systems for converting hydrogen-rich fuels into electricity. More specifically, aspects of this disclosure relate to devices for treating liquid from FCS exhaust streams.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively inexpensive cost, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

Hybrid-electric and full-electric powertrains take on various architectures, some of which utilize a fuel cell system (FCS) to generate the requisite electricity for powering the vehicle's electric traction motor(s). A fuel cell is an electrochemical device that is generally composed of an anode electrode that receives hydrogen (H₂), a cathode electrode that receives oxygen (O₂), and an electrolyte barrier interposed between the anode and cathode electrodes. An electrochemical reaction is induced to oxidize hydrogen molecules at the anode side of the FCS—hydrogen gas is catalytically split in an oxidation half-cell reaction—to generate free electrons (−) and free protons (H+). The free hydrogen protons pass through the electrolyte to the cathode, where these protons react with oxygen and electrons in the cathode to form stack reaction by-products. Free electrons from the anode, however, cannot pass through the electrolyte; these electrons are redirected to a load, such as a vehicle's traction motors and accessories, before being sent to the cathode.

Fuel cell architectures commonly employed in automotive applications contain a semipermeable polymer electrolyte membrane—also referred to as a “proton exchange membrane” or “PEM”—to provide ion transport between the anode and cathode. Proton exchange membrane fuel cells (PEMFC) generally employ a solid polymer electrolyte (SPE) proton-conducting membrane, such as a perfluorosulfonic acid membrane, to separate product gases and provide electrical insulation of the electrodes in addition to facilitating the conduction of protons. The anode and cathode typically include finely dispersed catalytic particles (e.g., platinum) that are supported on carbon particles and mixed with an ionomer. For some fuel cell manufacturing processes, this catalytic mixture may be deposited on the sides of the membrane to form the anode and cathode layers. The combination of the anode catalytic layer, cathode catalytic layer, and electrolyte membrane define a membrane electrode assembly (MEA) in which the anode catalyst and the cathode catalyst are supported on opposite faces of the ion conductive solid polymer membrane.

To generate the necessary electricity for powering a motor vehicle, numerous fuel cells are typically combined, in series or in parallel, into a fuel cell stack to achieve a higher output voltage and allow for stronger current draw. For example, a typical fuel cell stack for an automobile may have in excess of two hundred stacked cells. These fuel cell stacks receive reactant gas as a cathode input, typically as a metered flow of ambient air or concentrated gaseous oxygen forced through the stack by a compressor. During normal operation, a quantifiable mass of the oxygen is not consumed by the stack; some of the remnant oxygen is output as cathode waste gas that may include liquid water as a stack by-product. The fuel cell stack also receives hydrogen or hydrogen-rich reactant gas as an anode input that flows into the anode side of the stack. The distribution of hydrogen within the anode flow channels is typically held substantially constant for proper fuel cell stack operation. Exhaust generated as a byproduct of fuel cell operation may include water vapor, liquid water, air, and negligible levels of waste hydrogen and nitrogen gases. In some operational modes, waste hydrogen may be recycled and recirculated back into the fuel cell stack so that the anode gas is evenly distributed to achieve a calibrated stack output load. Additionally, a fuel cell stack may be operated in a manner that maintains the MEAs in a humidified state in which gases supplied to the fuel cell stack are humidified with waste water to prevent drying of the MEAs.

### SUMMARY

Disclosed herein is an exhaust liquid treatment assembly for a fuel cell system (FCS). The FCS includes a fuel cell stack and an FCS exhaust pipe fluidly connected to the fuel cell stack and configured to expel an exhaust stream from the FCS. The exhaust liquid treatment assembly includes a liquid tank having a liquid inlet in fluid communication with the FCS exhaust pipe and a liquid outlet. A liquid treatment filter separates the liquid inlet from the liquid outlet. The liquid treatment filter includes a pH controlling material configured to mix with a liquid passing through the liquid treatment filter. A liquid level sensor configured to determine a level of liquid in the liquid tank. A controller is in communication with the liquid level sensor and configured to regulate a level of the liquid within the liquid tank by selectively opening and closing an outlet valve in fluid communication with the liquid outlet.

Another aspect of the disclosure may be where the liquid treatment filter is cylindrical and at least partially defines an internal cavity configured to accept liquid from the liquid inlet.

Another aspect of the disclosure may be where the liquid treatment filter includes at least one of a first end plate or a second end plate.

Another aspect of the disclosure may be where the second end plate is spaced from a perimeter wall of the liquid tank.

Another aspect of the disclosure may be where the first end plate is spaced from a perimeter wall of the liquid tank.

Another aspect of the disclosure may be where the liquid tank includes a spring-loaded pressure relief valve.

Another aspect of the disclosure may be where the outlet valve includes a solenoid valve.

Another aspect of the disclosure may be where the controller is configured to estimate a volume of liquid within the liquid tank based on a hydrogen gas consumption and an accumulated mass intake air flow for the FCS.

Another aspect of the disclosure may include a pH sensor configured to determine a pH level of a liquid within the liquid tank, wherein the controller is configured to regulate the pH level of the liquid within the liquid tank by controlling a disbursement of a pH controlling material based on the pH level determined by the pH sensor.

Another aspect of the disclosure may include a pH sensor configured to determine a pH level of a liquid within the liquid tank, wherein the controller is configured to regulate the pH level of the liquid within the liquid tank by selectively activating a pump to circulate the liquid through the liquid treatment filter.

Another aspect of the disclosure may be where the pH controlling material includes a blend of calcite and magnesium oxide.

Disclosed herein is a motor vehicle. The motor vehicle includes a vehicle body, road wheels attached to the vehicle body, and an electric motor attached to the vehicle body and configured to drive one or more of the road wheels to thereby propel the motor vehicle. The motor vehicle also includes a fuel cell system (FCS) attached to the vehicle body and operable to power the electric motor. The FCS includes a fuel cell stack and an FCS exhaust pipe fluidly connected to the fuel cell stack to expel an exhaust stream from the FCS. An exhaust liquid treatment assembly is fluidly connected to the FCS exhaust pipe. A liquid treatment filter separates the liquid inlet from the liquid outlet. The liquid treatment filter includes a pH controlling material configured to mix with a liquid passing through the liquid treatment filter. A liquid level sensor configured to determine a level of liquid in the liquid tank. A controller is in communication with the liquid level sensor and configured to regulate a level of the liquid within the liquid tank by selectively opening and closing an outlet valve in fluid communication with the liquid outlet.

Disclosed herein is a method of treating exhaust liquid from a fuel cell stack in a vehicle. The method includes directing a liquid from an exhaust pipe fluidly connected to the fuel cell into a liquid tank. The liquid in the liquid tank passes through a liquid treatment filter. The liquid treatment filter includes a pH controlling material configured to mix with the liquid from the exhaust pipe. A level of liquid in the liquid tank selectively regulates opening and closing an outlet valve in fluid communication with a liquid outlet in the liquid tank.

### BRIEF DESCRIPTION OF THE DRAWINGS

FIG. 1 is an elevated, perspective-view illustration of a representative motor vehicle with an inset schematic illustration of a rechargeable energy storage system (RESS) containing a traction battery pack and a fuel cell system for operating the electric motor(s) of an electrified powertrain according to aspects of the disclosed concepts.

FIG. 2 schematically illustrates a cross-sectional view of an example exhaust liquid treatment assembly.

FIG. 3 schematically illustrates a cross-sectional view of another example exhaust liquid treatment assembly.

FIG. 4 schematically illustrates a cross-sectional view of a further example exhaust liquid treatment assembly.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference, or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this Detailed Description, unless specifically disclaimed: the singular includes the plural and vice versa; the words “and” and “or” shall be both conjunctive and disjunctive; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or a logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

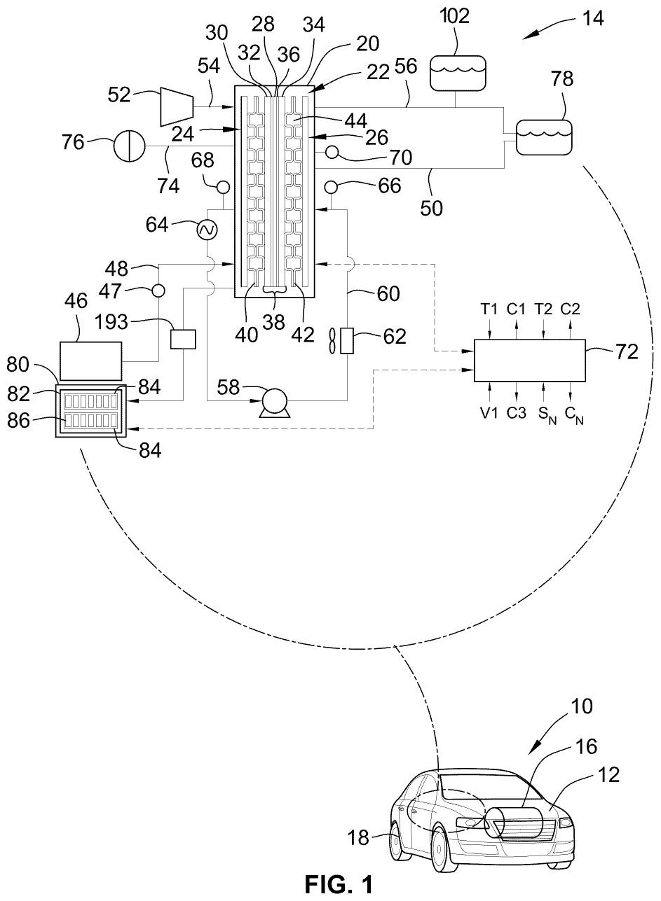

Referring now to the drawings, wherein like reference numbers refer to like features throughout the several views, there is shown in FIG. 1 a representative automobile, which is designated generally at 10 and portrayed herein for purposes of discussion as a sedan-style, fuel cell electric vehicle (FCEV). The illustrated automobile 10—also referred to herein as “motor vehicle” or “vehicle” for short—is merely an exemplary application with which aspects of this disclosure may be practiced. In the same vein, incorporation of the present concepts into the illustrated proton exchange membrane fuel cell (PEMFC) system should be appreciated as a non-limiting implementation of disclosed features. As such, it will be understood that aspects and features of this disclosure may be applied to other fuel cell system (FCS) architectures, incorporated into a logically relevant type of vehicle, and implemented for both automotive and non-automotive applications alike. Moreover, select components of the motor vehicles, fuel cell systems, and LG separator assemblies are shown and described in additional detail herein. Nevertheless, the vehicles, systems and assemblies discussed below may include numerous additional and alternative features, and other available peripheral components, for carrying out the various methods and functions of this disclosure.

Packaged within the vehicle body 12 of automobile 10 is a representative fuel cell system 14 for powering a prime mover, such as an electric motor generator unit (MGU) 16, that is operable for driving one or more of the vehicle's road wheels 18. Proton exchange membrane fuel cell system 14 of FIG. 1 is equipped with one or more fuel cell stacks 20, each of which is composed of multiple fuel cells 22 of the PEM type that are stacked and connected in electrical series or parallel with one another. In the illustrated architecture, each fuel cell 22 is a multi-layer construction with an anode side 24 and a cathode side 26 that are separated by a proton-conductive perfluorosulfonic acid membrane 28. An anode diffusion media layer 30 is provided on the anode side 24 of the PEMFC 22, with an anode catalyst layer 32 interposed between and operatively connecting the membrane 28 and corresponding diffusion media layer 30. Juxtaposed in opposing spaced relation to the anode layers 30 and 32 is a cathode diffusion media layer 34, which is provided on the cathode side 26 of the PEMFC 22. A cathode catalyst layer 36 is interposed between and operatively connects the membrane 28 and corresponding diffusion media layer 34. The two catalyst layers 32 and 36 cooperate with the membrane 28 to define, in whole or in part, a membrane electrode assembly (MEA) 38.

The diffusion media layers 30 and 34 are porous constructions that provide for fluid inlet transport to and fluid exhaust transport from the MEA 38. An anode flow field plate (or “first plate”) 40 is provided on the anode side 24 in abutting relation to the anode diffusion media layer 30. In the same vein, a cathode flow field plate (or “second plate”) 42 is provided on the cathode side 26 in abutting relation to the cathode diffusion media layer 34. Coolant flow channels 44 traverse each of the plates 40 and 42 to allow cooling fluid to flow through the fuel cell 22. Fluid inlet ports and headers direct a hydrogen-rich fuel and an oxidizing agent to respective passages in the anode and cathode flow field plates 40, 42. A central active region of the anode's plate 40 that faces the proton-conductive membrane 28 may be fabricated with an anode flow field composed of serpentine flow channels for distributing hydrogen over an opposing face of the membrane 28. The MEA 38 and plates 40, 42 may be stacked together between stainless steel clamping plates and monopolar end plates (not shown). These clamping plates may be electrically insulated from the end plates by a gasket or dielectric coating. The fuel cell system 14 may also employ anode recirculation where an anode recirculation gas is fed from an exhaust manifold or headers through an anode recirculation line for recycling hydrogen back to the anode side 24 input so as to conserve hydrogen gas in the stack 20.

Hydrogen (H₂) inlet flow—be it gaseous, concentrated, entrained, or otherwise-is transmitted from a hydrogen source, such as fuel storage tank 46, to the anode side 24 of the fuel cell stack 20 via a fluid injector 47 coupled to a (first) fluid intake conduit or hose 48. Anode exhaust exits the stack 20 via a (first) fluid exhaust conduit or hose 50. Although shown on the anode side of the stack, a compressor or pump 52 forces a cathode inlet flow, such as ambient air and/or concentrated gaseous oxygen (O₂), via a (second) fluid intake line or manifold 54 to the cathode side 26 of the stack 20. Cathode exhaust is output from the stack 20 via a (second) fluid exhaust conduit or hose 56. Flow control valves, flow restrictions, filters, and other available devices for regulating fluid flow can be implemented by the PEMFC system 14 of FIG. 1. Electricity generated by the fuel cell stack(s) 20 and output by the fuel cell system 14 may be transmitted for storage to an in-vehicle traction battery pack 82 within a rechargeable energy storage system (RESS) 80.

Fuel cell system 14 of FIG. 1 may also include a thermal sub-system operable for controlling the temperature of the fuel cell stack 20 during preconditioning, break-in, and post-conditioning. According to the illustrated example, a cooling fluid pump 58 pumps a cooling fluid through a coolant loop 60 to the fuel cell stack 20 and into the coolant channels 44 in each cell 22. A radiator 62 and an optional heater 64 fluidly coupled in the coolant loop 60 are used to maintain the stack 20 at a desired operating temperature. This fuel cell conditioning system may be equipped with various sensing devices for monitoring system operation and progress of fuel cell break-in. For instance, a (first) temperature sensor 66 monitors a temperature value of the coolant at a coolant inlet to the fuel cell stack 20, and a (second) temperature sensor 68 measures a temperature value of the coolant at a coolant outlet of the stack 20. An electrical connector or cable 74 connects the fuel cell stack 20 to an electric power load 76, which may be employed to draw a current from each cell 22 in the stack 20. A voltage/current sensor 70 is operable to measure, monitor, or otherwise detect fuel cell voltage and/or current across the fuel cells 22 in the stack 20.

Programmable electronic control unit (ECU) 72, such as a controller, helps to control operation of the fuel cell system 14. As an example, ECU 72 receives temperature signals T1 from temperature sensors 66, 68 that indicate the operating temperature of the fuel cell stack 20; ECU 72 may be programmed to responsively issue command signals C1 to modulate operation of the stack 20. ECU 72 of FIG. 1 also receives voltage signals V1 from a voltage sensor/current 70; ECU 72 may be programmed to responsively issue command signals C2 to modulate operation of a hydrogen source (e.g., fuel storage tank 46) and/or compressor/pump 52 to thereby regulate the electrical output of the stack 20. ECU 72 of FIG. 1 is also shown receiving coolant temperature signals T2 from sensor 66 and/or 68; ECU 72 may be programmed to responsively issue command signals C3 to modulate operation of the fuel cell's thermal system. Additional sensor signals SN may be received by, and additional control commands CN may be issued from the ECU 72, e.g., to control other sub-system or component illustrated and/or described herein. The ECU 72 may emit a command signal to transmit evolved hydrogen and liquid H₂O from the cathode side 26 through fluid exhaust conduit 56 to a storage tank 78 (FIG. 1) where hydrogen and water from the cathode are combined with depleted hydrogen exhausted from the anode through fluid exhaust conduit/hose 50.

With continuing reference to FIG. 1, the traction battery pack 82 of RESS 80 may contain an array of rechargeable lithium-class (secondary) battery modules 84. Aspects of the disclosed concepts may be similarly applicable to other electric storage unit architectures, including those employing nickel metal hydride (NiMH) batteries, solid-state (SS) batteries, lithium-metal and lithium-sulfur batteries, or other applicable type of rechargeable electric vehicle battery (EVB). Each battery module 84 may include a series of electrochemical battery cells, such as pouch-type lithium ion (Li-ion) or Li-ion polymer battery cells 86. An individual battery module 84, for example, may be typified by a grouping of 10-45 Li-ion battery cells that are stacked in side-by-side facing relation with one another and connected in parallel or series for storing and supplying electrical energy. While described as silicon-based, Li-ion “pouch cell” batteries, the cells 86 may be adapted to other constructions, including cylindrical and prismatic constructions. To boost the voltage output of the vehicle FCS, a respective DC-to-DC boost converter (DC CON) may be electrically interposed between the fuel cell stack 20 and the RESS 80.

During operation of the automobile 10, the vehicle's fuel cell system 14 produces exhaust that may contain liquid water, humidified air entrained with water vapor, low levels of waste hydrogen gas, and other non-toxic trace elements. For some vehicle configurations, these byproducts of FCS operation are expelled from the vehicle; when the vehicle is stationary, liquid water entrained within the FCS exhaust stream may be ejected onto the road surface and may amalgamate into a puddle. While some FCEV architectures may recycle metered amounts of wastewater back into the FCS, e.g., to humidify the cell stack, or stow wastewater in an on-vehicle storage tank, e.g., for drinking, most do not provide a means for routing exhaust water away from the vehicle using an auxiliary device. Those vehicles that are plumbed with hardware for managing FCS exhaust water typically employ expensive and complicated electromechanical devices or cumbersome mechanical devices that require moving parts and large amounts of packing space.

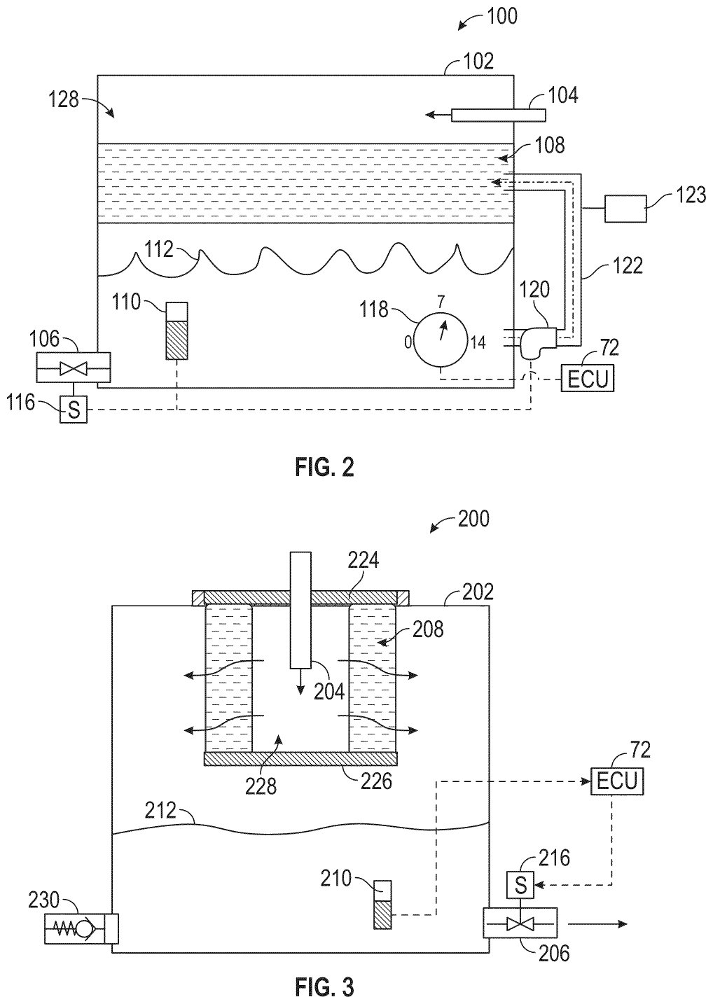

FIG. 2 illustrates an exhaust liquid treatment assembly 100. The assembly 100 includes a liquid tank 102 having a perimeter wall for storing liquid, such as water, generated by the FCS during operation. In particular, the liquid tank 102 can store liquid generated by the FCS when the automobile 10 is stationary. One feature of this arrangement is to prevent the accumulation of the liquid on a floor surface while the automobile 10 is stationary. Furthermore, the assembly 100 can filter and treat the liquid to maintain it within a predetermined pH range prior to emptying the liquid tank 102. In one example, the liquid tank 102 is emptied when the automobile 10 begins traveling or the liquid tank 102 is emptied into a larger holding or treatment tank when the automobile 10 is stationary.

The assembly 100 collects liquid within the exhaust pipe 56 through an inlet 102 into the tank 102. In the illustrated example, the inlet 104 is located in an upper portion of the tank 102 in a cavity 128. The cavity 128 is located on a first side of a liquid treatment filter 108 and at least partially defined by a wall of the tank 102. The tank 102 also includes a liquid outlet 106 in a lower portion of the tank 102. The liquid outlet 106 is on a second or opposite side of the liquid treatment filter 108 from the inlet 104. This directs liquid entering the tank 102 to pass through the liquid treatment filter 108 before leaving the tank 102.

The liquid treatment filter 108 can include a replaceable cartridge that filters particles from the liquid entering the tank 102 as well as dispenses a pH controlling material into the liquid as it passes through the liquid treatment filter 108. In one example, the pH controlling material that mixes with the liquid as it passes through the treatment filter 108 includes a combination of calcite and magnesium oxide. The combination of calcite and magnesium oxide can be selected based on an average pH of the liquid entering the tank 102.

In one example, a liquid level sensor 110 is located within the tank 102 to measure a level 112 of liquid that has accumulated in the liquid tank 102. In one example, the liquid level sensor 110 can include a float or at least one switch that triggers when submersed in liquid.

The ECU 72 is in electrical communication with the liquid level sensor and is configured to regulate the level 112 of liquid within the liquid tank 102. The ECU 72 can also estimate a level 112 of liquid within the tank 102 based on receiving a measurement of an amount of hydrogen gas consumed by the FCS and an accumulated mass intake air flow for the FCS.

The ECU 72 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The ECU 72 may include a non-transitory computer-readable medium that stores instructions which, when processed by one or more processors of the ECU 72, implement a method 100 of developing a disparity estimation neural network, according to one or more embodiments detailed herein. The ECU 72 can operate programs that perform artificial intelligence. However, this disclosure applies to decision-making systems that utilize or generate vectors, such as probability or confidence vectors, in the decision-making process.

The ECU 72 can also regulate the level 112 of liquid within the tank 102 by selectively opening and closing an outlet valve 116, such as a solenoid valve, to allow fluid to pass through the liquid outlet 106. The ECU 72 can also regulate the level of liquid in the tank 102 by opening the outlet valve 116 when the automobile 10 is in motion and maintaining the outlet valve in a closed position until the level 112 of liquid in the tank reaches a maximum level. If the liquid level sensor 110 determines that the tank 102 has reached a maximum level, the controller module can direct the FCS to direct the liquid form the exhaust pipe 56 to be directed out of the automobile 10 in a traditional manner.

The assembly 100 can also include a pH sensor 118 in electrical communication with the ECU 72. The pH sensor 118 is configured to determine a pH level of the liquid in the tank 102 and communicate that information to the ECU 72. If a pH level of the liquid within the tank 102 is outside of a predetermined range, the ECU 72 can active a pump 120 that circulates the liquid through a conduit 122 back through the treatment filter 108 to allow for a greater amount of pH controlling material to be dispersed within the liquid in order to maintain the pH of the liquid within the tank 102 at a desired level. Alternatively, additional pH controlling material from storage container 123 can be dispersed into the conduit 122 when the pump 120 circulates the liquid in the tank 102.

FIG. 3 illustrates another example exhaust liquid treatment assembly 200. The exhaust liquid treatment assembly 200 is similar to the exhaust treatment assembly 100 except where described below or shown in the drawings. The assembly 200 will replace the leading “1” from the assembly 100 with a leading “2” to identify similar or identical elements.

The assembly 200 collects fluid in a tank 202 from liquid within the exhaust pipe 56 that enters the tank 202 through an inlet 204. In the illustrated example, the inlet 204 is located in an upper portion of the tank 202 and directs the liquid into a central region of a liquid treatment filter 208. The tank 102 also includes a liquid outlet 206 in a lower portion of the tank 202 that directs liquid entering the tank 202 to pass through the liquid treatment filter 208 before leaving the tank 202.

In the illustrated example, the liquid treatment filter 208 includes a replaceable cartridge that is cylindrical in shape. The liquid treatment filter 208 also includes at least one of a tank wall or a first end plate 224 adjacent a first axial end of the liquid treatment filter 208 and a second end plate 226 adjacent a second axial end of the liquid treatment filter 208. The tank wall or the first end plate 224, the second end plate 226, and the liquid treatment filter 208 at least partially define a liquid treatment cavity 228.

In one example, a liquid level sensor 210 is located within the tank 202 to measure a level 212 of liquid that has accumulated in the liquid tank 202. In one example, the liquid level sensor 210 can include a float or at least one switch that triggers when submersed in liquid.

The ECU 72 is in electrical communication with the liquid level sensor 210 and is configured to regulate the level 212 of liquid within the liquid tank 202. The ECU 72 regulates the level of liquid within the tank 202 by selectively opening and closing an outlet valve 216 to allow fluid to pass through the liquid outlet 106. The assembly 200 can also include a pressure relief valve 230, such as a spring-loaded ball valve to prevent the tank 202 from overfilling.

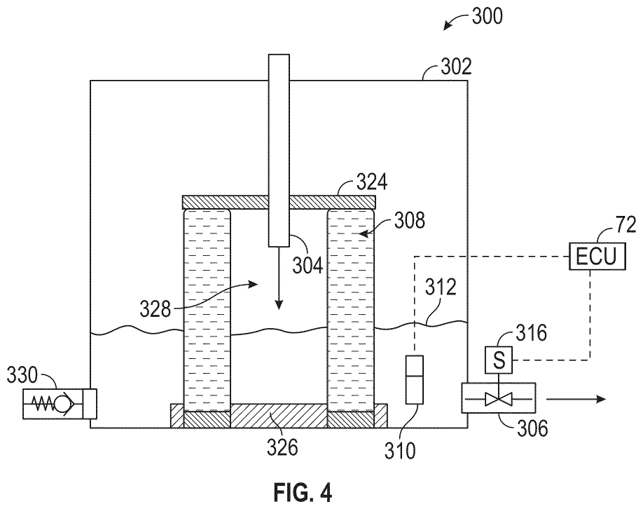

FIG. 4 illustrates another example exhaust liquid treatment assembly 300. The exhaust liquid treatment assembly 300 is similar to the exhaust treatment assembly 100 except where described below or shown in the drawings. The assembly 300 will replace the leading “1” from the assembly 100 with a leading “3” to identify similar or identical elements.

The assembly 300 collects fluid in a tank 302 from liquid within the exhaust pipe 56 that enters the tank 302 through an inlet 304. In the illustrated example, the inlet 304 is located in an upper portion of the tank 302 and directs the liquid into a central region of a liquid treatment filter 308. The tank 302 also includes a liquid outlet 306 in a lower portion of the tank 302 that directs liquid entering the tank 302 to pass through the liquid treatment filter 308 before leaving the tank 302.

In the illustrated example, the liquid treatment filter 308 includes a replaceable cartridge that is cylindrical in shape. The liquid treatment filter 308 also includes a first end plate 324 adjacent a first axial end of the liquid treatment filter 308 and at least one of a tank wall or a second end plate 326 adjacent a second axial end of the liquid treatment filter 308. The tank wall or the first end plate 324, the second end plate 326, and the liquid treatment filter 308 at least partially define a liquid treatment cavity 328.

In one example, a liquid level sensor 310 is located within the tank 302 to measure a level 312 of liquid that has accumulated in the liquid tank 302. In one example, the liquid level sensor 310 can include a float or at least one switch that triggers when submersed in liquid.

ECU 72 is in electrical communication with the liquid level sensor 310 and is configured to regulate the level 312 of liquid within the liquid tank 302. The ECU 72 regulates the level of liquid within the tank 302 by selectively opening and closing an outlet valve 316 to allow fluid to pass through the liquid outlet 306. The assembly 300 can also include a pressure relief valve 330, such as a spring-loaded ball valve, to prevent the tank 302 from overfilling.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. An exhaust liquid treatment assembly for a fuel cell system (FCS), the FCS including a fuel cell stack and an FCS exhaust pipe fluidly connected to the fuel cell stack and configured to expel an exhaust stream from the FCS, the exhaust liquid treatment assembly comprising:
a liquid tank having a liquid inlet in fluid communication with the FCS exhaust pipe and a liquid outlet;
a liquid treatment filter separating the liquid inlet from the liquid outlet, wherein the liquid treatment filter includes a pH controlling material configured to mix with a liquid passing through the liquid treatment filter;
a liquid level sensor configured to determine a level of liquid in the liquid tank; and
a controller in communication with the liquid level sensor and configured to regulate a level of the liquid within the liquid tank by selectively opening and closing an outlet valve in fluid communication with the liquid outlet.

2. The exhaust liquid treatment assembly of claim 1, wherein the liquid treatment filter is cylindrical and at least partially defines an internal cavity configured to accept liquid from the liquid inlet.

3. The exhaust liquid treatment assembly of claim 2, wherein the liquid treatment filter includes at least one of a first end plate or a second end plate.

4. The exhaust liquid treatment assembly of claim 3, wherein the second end plate is spaced from a perimeter wall of the liquid tank.

5. The exhaust liquid treatment assembly of claim 3, wherein the first end plate is spaced from a perimeter wall of the liquid tank.

6. The exhaust liquid treatment assembly of claim 1, wherein the liquid tank includes a spring-loaded pressure relief valve configured to release liquid from the liquid tank.

7. The exhaust liquid treatment assembly of claim 1, wherein the outlet valve includes a solenoid valve.

8. The exhaust liquid treatment assembly of claim 1, wherein the controller is configured to estimate a volume of liquid within the liquid tank based on a hydrogen gas consumption and an accumulated mass intake air flow for the FCS.

9. The exhaust liquid treatment assembly of claim 1, including a pH sensor configured to determine a pH level of a liquid within the liquid tank, wherein the controller is configured to regulate the pH level of the liquid within the liquid tank by controlling a disbursement of a pH controlling material based on the pH level determined by the pH sensor.

10. The exhaust liquid treatment assembly of claim 1, including a pH sensor configured to determine a pH level of a liquid within the liquid tank, wherein the controller is configured to regulate the pH level of the liquid within the liquid tank by selectively activating a pump to circulate the liquid through the liquid treatment filter.

11. The exhaust liquid treatment assembly of claim 1, wherein the pH controlling material includes a blend of calcite and magnesium oxide.

12. A motor vehicle, comprising:
a vehicle body;
a plurality of road wheels attached to the vehicle body;
an electric motor attached to the vehicle body and configured to drive one or more of the road wheels to thereby propel the motor vehicle;
a fuel cell system (FCS) attached to the vehicle body and operable to power the electric motor, the FCS including a fuel cell stack and an FCS exhaust pipe fluidly connected to the fuel cell stack to expel an exhaust stream from the FCS; and
an exhaust liquid treatment assembly fluidly connected to the FCS exhaust pipe, the exhaust liquid treatment assembly including:
a liquid tank having a liquid inlet in fluid communication with the FCS exhaust pipe and a liquid outlet;
a liquid treatment filter separating the liquid inlet from the liquid outlet, wherein the liquid treatment filter includes a pH controlling material configured to mix with a liquid passing through the liquid treatment filter;
a liquid level sensor configured to determine a level of liquid in the liquid tank; and
a controller in communication with the liquid level sensor and configured to regulate a level of the liquid within the liquid tank by selectively opening and closing an outlet valve in fluid communication with the liquid outlet.

13. The motor vehicle of claim 12, wherein the liquid treatment filter is cylindrical and at least partially defines an internal cavity configured to accept liquid from the liquid inlet.

14. The motor vehicle of claim 13, wherein the liquid treatment filter includes at least one of a first end plate or a second end plate.

15. The motor vehicle of claim 14, wherein one of the first end plate or the second end plate is spaced from a perimeter wall of the liquid tank.

16. The motor vehicle of claim 12, wherein the controller is configured to estimate a volume of liquid within the liquid tank based on a hydrogen gas consumption and an accumulated mass intake air flow for the FCS.

17. The motor vehicle of claim 12, including a pH sensor configured to determine a pH level of a liquid within the liquid tank, wherein the controller is configured to regulate the pH level of the liquid within the liquid tank by controlling a disbursement of a pH controlling material based on the pH level determined by the pH sensor.

18. The motor vehicle of claim 12, including a pH sensor configured to determine a pH level of a liquid within the liquid tank, wherein the controller is configured to regulate the pH level of the liquid within the liquid tank by selectively activating a pump to circulate the liquid through the liquid treatment filter.

19. A method of treating exhaust liquid from a fuel cell stack in a vehicle, the method comprising:
directing a liquid from an exhaust pipe fluidly connected to the fuel cell into a liquid tank;
passing the liquid in the liquid tank through a liquid treatment filter, wherein the liquid treatment filter includes a pH controlling material configured to mix with the liquid from the exhaust pipe; and
regulating a level of liquid in the liquid tank selectively opening and closing an outlet valve in fluid communication with a liquid outlet in the liquid tank.

20. The method of claim 19, wherein the controller is configured to selectively open the outlet valve when the vehicle is in motion.
